(19) United States
(12) Patent Application Publication
(10) Pub. No.: US 2007/0257077 A1
(43) Pub. Date: Nov. 8, 2007

(54) Component, Particulary for a Vehicle, Which is Capable of Folding About a Folding Axis, and a Fastener

(75) Inventors: Fritz Jost, Grefrath (DE); Holger Langmann, Wiesbaden (DE)

Correspondence Address: FOLEY & LARDNER LLP, 777 EAST WISCONSIN AVENUE, MILWAUKEE, WI, 53202-5306, US

(73) Assignee: JOHNSON CONTROLS INTERIORS GMBH CO. KG, Grefrath (DE)

(21) Appl. No.: 10/587,877

(22) PCT Filed: Jan. 7, 2005
(86) PCT No.: PCT/EP05/00078

§ 371 Date: Jun. 5, 2007

(30) Foreign Application Priority Data
Jan. 30, 2004 (DE) 10 2004 004 983.1

(51) Int. Cl. B60R 7/06

(52) U.S. Cl. 224/483

(57) ABSTRACT

The invention relates to a component (1), particularly for a vehicle, which can pivot about a pivot axis (2) and is provided for interacting with a fastening element (7). Said component (1) comprises a rotating element (3) that can rotate about a rotation axis, this rotation axis (6) forming an angle with the pivot axis (2).

### CROSS REFERENCE TO RELATED APPLICATIONS

The present invention claims priority as a national stage application of International Patent Application Serial No. PCT/EP 04/014012 filed on Jan. 7, 2005; and German Patent Application Serial No. DE 102004004983.1 filed on Jan. 30, 2004, which are both hereby incorporated herein by reference in their entirety.

### BACKGROUND

The present invention relates to a component, particularly for a vehicle, which is capable of folding about a folding axis and is intended to interact with a fastener.

Trim components, in vehicles for example, may be very costly. Flaps and covers, for closing compartments, for example, especially in vehicles or furniture, are often equipped with springs so as to facilitate opening and/or closing by the user. Trim components should be fundamentally inexpensive to manufacture and easy for the user to operate.

### SUMMARY

The object of the invention is to create a trim component which is capable of folding about a folding axis, which has as few parts as possible, which is inexpensive to manufacture and which is easy for the user to operate.

The object is achieved by a component, particularly for a vehicle, which is capable of folding about a folding axis and is intended to interact with a fastener, the component comprising a rotating element, capable of rotating about an axis of rotation, the axis of rotation forming an angle with the folding axis or being arranged offset in relation to the folding axis.

In folding the component according to the invention the rotating element with the component is rotated relative to the fastener or the rotating element rotates with the fastener relative to the component. At the same time according to the invention the axis of rotation of the rotating element forms an angle with the folding axis of the component, or the folding axis and the axis of rotation are offset, that is to say they are arranged parallel and non-aligning; according to the invention the term misalignment is also used. The component may be intended, in particular, as a glove compartment or as a glove compartment lid or may be any vehicle interior trim part in general.

In contrast to a component according to the invention a door, for example, can be folded about a general axis of rotation—the folding axis. The door is usually suspended on at least two door hinges, which are arranged in alignment with one another and the axes of rotation of which consequently coincide with the folding axis. If the (local) axis of rotation for at least one of the door hinges is tilted or the door hinges are arranged offset in relation to one another, that is to say they no longer align, stresses are generated in the door, the door hinges and/or in the door case. According to the invention use is made of such stresses or such misalignments in a component according to the invention. The term folding axis will therefore hereinafter be used to mean the “general” axis of rotation, and reference will be made to the (local) axis of rotation of the rotating elements, which is also termed the hinge axis. According to the invention, the folding axis and the axis of rotation, at least in each rotating element, do not coincide.

The angle formed by the axis of rotation of the rotating element with the folding axis of the component according to the invention or their offset produces stresses in the material of the rotating element, of the component and/or of the fastener.

The person skilled in the art will appreciate that the stress generated in the folding of the component leads to deformations of the component and/or of the fastener and/or of the rotating element that vary as a function of the material, as when different metals or metal alloys are used as opposed to different plastics, for example, and as a function of the shape, as when inserting ribs or modifying the material thickness, for example. The person skilled in the art will likewise appreciate that for the same material and the same shape a larger angle between the axis of rotation of the rotating element and the folding axis produces a greater stress. The material and the shape of the component and/or of the fastener and/or of the rotating element must therefore be designed so that the stress caused by the folding does not lead to an irreversible plastic deformation and that any binding of the component or the fastener against the rotating element is reliably prevented.

The object is further achieved by a component, a folding of the component producing an elastic stress in the component, the elastic stress causing a restoring force, which acts on the component. In a further, likewise preferred embodiment a folding of the component produces an elastic stress in the rotating element, the elastic stress causing a restoring force, which acts on the component. The elastic stress is produced by a deformation of the component, of the fastener and/or of the rotating element when folding the component. The deformation is reversible, so that the stored energy is released when the component is folded back. This manifests itself as a restoring force. Since the deformation of the component, of the fastener and/or of the rotating element varies as a function of the material and the shape of the component, the force curve for the restoring force produced by the deformation can be purposely influenced by varying the material and the shape of the parts.

According to the invention the material and the shape of the rotating element, of the component and/or of the fastener are selected so that despite the deformation occurring any binding of the rotating element against the component and/or the fastener is reliably prevented. This means that despite the stress, which according to the invention is at least partially present, the component in basically any folded position is relatively free-running in response to further folding or folding back.

The restoring force alters the force actually required of the user when folding the component in comparison to the situation without the restoring force, and can advantageously assist the operation by the user. In general terms the folding axis does not pass through the center of gravity of the component, so that the weight of the component in some folded positions, for example, leads to further opening of the component or to further folding. In such a case a user would have to overcome the effect of the weight when folding back. According to the invention the restoring force can act in such a way that the user is assisted in such a situation, that is to say, for example, that less force is needed for closing.

The component and/or the rotating element is shaped so that the force curve of the restoring force is non-linear.

Adjustments to the gradient, such as inflection points, can advantageously be provided in the force curve so that the restoring force when folding the component can assume local maximum and minimum values. This means, for example, that it is possible to achieve force curves for the force actually required of the user, which act as detent points for the user, providing him with preferred opening angles of the component and making it possible to purposely assist or facilitate folding of the component by the user.

The restoring force preferably compensates for the gravitational force, so that adjustment of the effective component of the weight when folding the component is not discernible by the user, particularly when the effective component of the weight is great. This facilitates operation of the component by the user.

In a preferred embodiment the component comprises two rotating elements, at least one of the axes of rotation of the rotating elements forming an angle with the folding axis, or being arranged offset in relation to the folding axis. The elastic stress is therefore achievable with just one rotating element, the axis of rotation of which forms an angle with the folding axis of the component, whilst the axis of rotation of the second rotating element need not form an angle with the folding axis of the component. However, the axes of rotation of both rotating elements advantageously form an angle with the folding axis, the latter preferably having the same value and the axes of rotation of the rotating elements preferably also forming an angle with one another. Given a corresponding choice of material and shape for the component, the fastener and/or the rotating elements, the elastic stress produced is thereby basically distributed uniformly, so that the loading on the component parts is reduced.

The two rotating elements are preferably arranged basically mirror-symmetrically about an imaginary plane perpendicular to the folding axis. The rotating elements can thereby be basically identical, so that the number of components is reduced. This is cost-effective with regard to the stocking and production of components.

The angle between the axis/axes of rotation and the folding axis is preferably approximately 5°-15°. The greater the chosen angle between the axis of rotation and the folding axis, the greater the stress in the component, the fastener and/or the rotating element for the same material and the same shape. The chosen material and the shape of these parts must be all the more elastic in order that the stress does not lead to an irreversible plastic deformation, causing the parts to bind against one another and giving rise to folding noise.

The rotating element is preferably cylindrical, and in particular takes the form of a pin or tube. These parts are easy and therefore inexpensive to manufacture.

The component according to the invention can be easily and cost efficiently manufactured using few parts. The facility for adjustment of the force curve through selection of the material and the shape according to the invention makes folding the component easy for the user.

A further subject of the present invention is a fastener for interaction with a component according to the invention, the fastener comprising a rotating element, the rotating element being capable of rotating about an axis of rotation, which forms an angle with the folding axis of the component or is arranged offset in relation to the folding axis.

A further subject of the present invention is a fastener for interaction with a component according to the invention, a folding of the component producing an elastic stress in the fastener, the elastic stress causing a restoring force, which acts on the component.

In a preferred embodiment the fastener is a seating mount for supporting the rotating element.

According to the invention the material and the shape of the fastener, the component and/or the rotating element, together with the angle that the axis of rotation of the rotating element forms with the folding axis of the component, are selected so that no irreversible plastic deformation of the component, the fastener and/or the rotating element occurs when folding the component. Furthermore, a force curve for the restoring force is preferably achieved, which assists the user in operation of the component.

### BRIEF DESCRIPTION OF THE DRAWINGS

The invention will be described below with reference to FIGS. 1-3. The descriptions serve only as examples and do not limit the general idea of the invention.

FIG. 1 shows a side view of one embodiment of a vehicle glove compartment according to the invention.

FIG. 2 shows a partial view of the glove compartment in FIG. 1.

FIG. 3 shows a detail of a cockpit of an automobile.

### DETAILED DESCRIPTION OF PREFERRED AND EXEMPLARY EMBODIMENTS

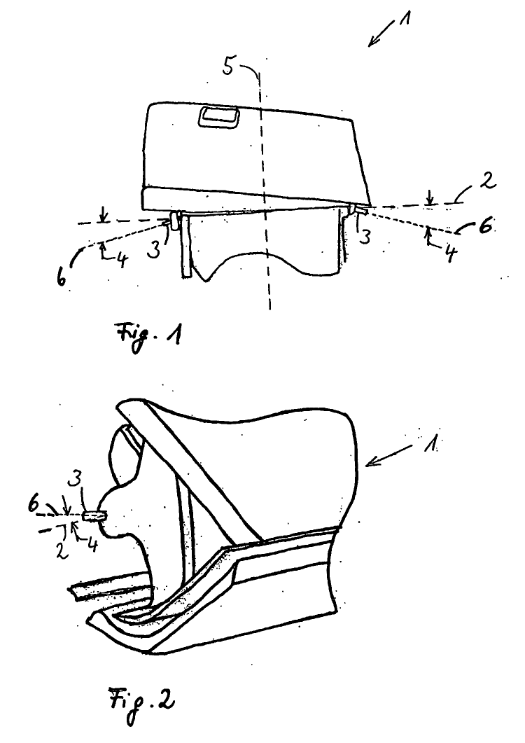

FIG. 1 shows a vehicle glove compartment 1 as an example of a component 1. The glove compartment 1 is capable of being folded about a folding axis 2. For fastening the glove compartment 1, in a vehicle cockpit, for example, it comprises two rotating elements 3 in the form of pins 3, which each have an axis of rotation 6, the axes of rotation 6 each forming an angle 4 with the folding axis 2. The rotating elements 3 are arranged basically symmetrically about an imaginary plane 5 perpendicular to the folding axis 2. Fasteners 7 for fastening the glove compartment 1 in the cockpit are not visible in FIG. 1. The person skilled in the art will recognize that said fasteners are cylindrical sleeves or seating mounts, in which the pins 3 are supported. When opening the glove compartment 1, the rotating elements 3 are rotated in the sleeves or seating mounts about the axis of rotation 6, which forms the angle 4 with the folding axis 2 of the glove compartment 1. An elastic stress is thereby generated, which can be influenced by a corresponding choice of material and shape for the glove compartment 1, the fasteners 7 and/or the pins 3. The material of the glove compartment 1, the fastener 7 and/or the pins 3 is at the same basically elastically deformed. This leads to a (reversible) elastic stress, which produces a preferably non-linear restoring force. Through suitable choice of the material and the shape, the curve for the restoring force is preferably designed so that opening of the glove compartment 1 is damped and the force actually required of the user when closing the glove compartment 1 is [lacuna], making operation of the glove compartment 1 easier for the user.

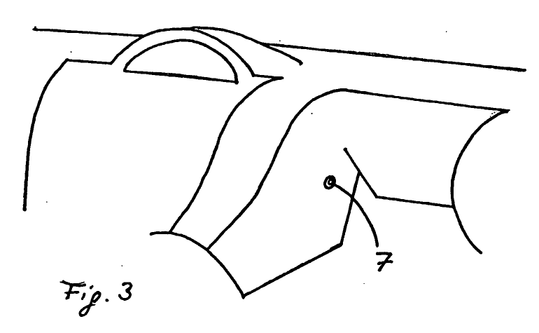

FIG. 2, by way of illustration, shows a partial detail of the glove compartment 1 from another perspective. Visible in the figure is the pin 3, the axis of rotation 6 of which forms the angle 4 with the folding axis 2 of the component.

FIG. 3 shows a detail of an automobile cockpit. In this embodiment the cockpit by way of fasteners 7 has seating mounts for supporting the pin-shaped rotating elements 3 of the glove compartment 1, only one of the two seating mounts 7 being visible.

One possible embodiment (not shown) of the fastener is a cockpit, which comprises the rotating elements 3 and which therefore itself represents the fastener 7.

The component 1 according to the invention and the fastener 7 can be used in a number of different types of vehicle, such as automobiles, ships or aircraft, for example. They can also be used as trim components for furniture.

### LIST OF REFERENCE NUMERALS

1. Component, glove compartment
2. Folding Axis
3. Rotating element, pin
4. Angle between the folding axis and the axis of rotation of a rotating element
5. Imaginary plane perpendicular to the folding axis
6. Axis of rotation of a rotating element
7. Fastener, seating mount for supporting a rotating element

1-12. (canceled)

13. A vehicle component comprising:
a base;
a door coupled to the base and configured to fold about a folding axis between an open position and a closed position;
a pin coupling the door to the base and having an axis of rotation offset relative to the folding axis.

14. The component of claim 13 wherein the folding axis extends at an angle relative to the folding axis.

15. The vehicle component of claim 14 wherein the angle is between approximately 5 degrees and 15 degrees.

16. The component of claim 13 wherein rotating the door between the open position and the closed position produces an elastic stress in the base and the pin.

17. The component of claim 16 wherein the elastic stress provides a restoring force that acts on the door.

18. The component of claim 17 wherein the restoring force is configured to dampen the movement of the door from the closed position to the open position and decrease the force required to move the door from the open position to the closed position.

19. The vehicle component of claim 18 wherein the restoring force is non-linear.

20. The vehicle component of claim 17 wherein the restoring force compensates for the gravitational force.

21. The vehicle component of claim 13 wherein the pin is cylindrical.

22. The vehicle component of claim 21 wherein the pin is a tube.

23. The vehicle component of claim 13 further comprising a sleeve disposed in the base and configured to receive and support the pin.

24. The component of claim 13 wherein the pin comprises a pair of outwardly extending pins.

25. The component of claim 24 wherein the pins are arranged symmetrically about a plane perpendicular to the folding axis.

26. A glove compartment assembly comprising:
a base having a pair of seating mounts;
a door coupled to the base and configured to fold about a folding axis between an open position and a closed position, the door comprising a pair of pins that engage the seating mounts, each having an axis of rotation offset relative to the folding axis.

27. The component of claim 26 wherein rotating the door between the open position and the closed position produces an elastic stress in the base and the pin that provides a non-linear restoring force that acts on the door.

28. The component of claim 27 wherein the restoring force is configured to dampen the movement of the door from the closed position to the open position and decrease the force required to move the door from the open position to the closed position.

29. The component of claim 26 wherein the pins are arranged symmetrically about a plane perpendicular to the folding axis.

30. A vehicle cockpit comprising:
a base having a pair of seating mounts;
a door coupled to the base and configured to fold about a folding axis between an open position and a closed position, the door comprising a pair of pins that engage the seating mounts;
wherein each of the pins have an axis of rotation disposed at an angle relative to the folding axis.

31. The vehicle component of claim 30 wherein the angle is between approximately 5 degrees and 15 degrees.

32. The component of claim 30 wherein rotation of the door between the open position and the closed position produces an elastic stress in the base and the pin.
